(19) United States
(12) Patent Application Publication
(10) Pub. No.: US 2005/0262433 A1
(43) Pub. Date: Nov. 24, 2005

(54) Computer product, data analysis support method, and data analysis support apparatus

(75) Inventors: Hiroyuki Suzuki, Kawasaki (JP); Masaharu Koyabu, Kawasaki (JP); Tsuneichi Yoshizawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/953,644

(22) Filed: Sep. 29, 2004

(30) Foreign Application Priority Data
May 6, 2004 (JP) 2004-137115

(51) Int. Cl. G06F 15/00

(52) U.S. Cl. 715/513

(57) ABSTRACT

Undefined data yet to be stored in a data warehouse is collected from a core database of each sales department to a server, wherein it is once converted to XML files. A “virtual table” of the same format as that of a table in the data warehouse is created from the files, and various data processing, such as summation, is carried out for the virtual table. By this processing, even undefined data yet to be subjected to normalization or cleansing can be referred to and analyzed in the same manner as is the case with defined data stored in the data warehouse. By combining the table in the data warehouse with the virtual table, it is also possible to make a seamless data analysis of the defined and undefined data.

### CROSS-REFERENCE TO RELATED APPLICATIONS

This application is based upon and claims the benefit of priority from the prior Japanese Patent Application No. 2004-137115, filed on May 6, 2004, the entire contents of which are incorporated herein by reference.

### BACKGROUND OF THE INVENTION

1) Field of the Invention

The present invention relates to a data analysis support program, a data analysis support method, and a data analysis support apparatus for supporting user's data analysis by On Line Analytical Processing (OLAP).

2) Description of the Related Art

In corporations or the like, it is a general practice to extract required data from a core database used for business operations of various sales departments and build a corporation-wide information database (data warehouse) with the extracted data for many-sided, diversified data analysis using the technique of OLAP (For example, see Japanese Patent Publication No. 3302522).

In the conventional OLAP, however, the data that can be analyzed (hereinafter, “defined data”) is limited only to those stored in the data warehouse. Storing data in the data warehouse calls for conventional normalization or cleansing of data (unification of data designation and format, removal of incomplete data, etc.) or redefinition of the schema of the host database; hence, there is usually a time lag between the creation of data in each department and its reflection in the data warehouse. Since the data prior to reflection (hereinafter, “undefined data”) is not analyzed by OLAP, it is impossible to make a real-time analysis of patterns of sales (undefined data), for instance, though possible to analyze patterns of sales obtained until several days before (defined data).

### SUMMARY OF THE INVENTION

It is an object of the present invention to solve at least the problems in the conventional technology.

A computer program according to an aspect of the present invention contains instructions which when executed on a computer cause the computer to execute creating a markup document from data yet to be stored in a data warehouse; searching a markup document, from among the markup documents created, for a tag corresponding to an item of a designated table; extracting data in the tag from hit markup document; creating a designated table with the data extracted as a value of the item; and processing data in the designated table created to a designated format.

A data analysis support method according to another aspect of the present invention includes creating a markup document from data yet to be stored in a data warehouse; searching a markup document, from among the markup documents created, for a tag corresponding to an item of a designated table; extracting data in the tag from hit markup document; creating a designated table with the data extracted as a value of the item; and processing data in the designated table created to a designated format.

A data analysis support apparatus according to still another aspect of the present invention includes a document creating unit that creates a markup document from data yet to be stored in a data warehouse; a searching unit that searches a markup document, from among the markup documents created, for a tag corresponding to an item of a designated table; an extracting unit that extracts data in the tag from hit markup document; a table creating unit that creates the designated table with the data extracted as a value of the item; and a data processing unit that processes data in the designated table created to a designated format.

A computer-readable recording medium according to still another aspect of the present invention stores the above computer program.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a hardware configuration of a data analysis support apparatus according to an embodiment of the present invention;

FIG. 2 is a functional configuration of a data analysis support system including the data analysis support apparatus according to the embodiment;

FIG. 3 is an example of unconverted source data and converted Extensible Markup Language (XML) data;

FIG. 4 is another example of the unconverted source data and the converted XML data;

FIG. 5 is an explanatory diagram of, by way of a schematic example, a virtual table definition and a virtual table based on the definition;

FIG. 6 is an explanatory diagram an example of a two-dimensional table that is created by a data processor;

FIG. 7 is a flowchart of a process procedure for processing undefined data in the data analysis support apparatus according to the embodiment;

FIG. 8 is an explanatory diagram of an example of a display of a condition input screen in a client;

FIG. 9 is a schematic explanatory diagram of the total summation by the data processor;

FIG. 10 is an explanatory diagram of a schematic example of a table including both defined and undefined data;

FIG. 11 is an explanatory diagram of an example of a two-dimensional table created from the table in FIG. 10; and

FIG. 12 is an explanatory diagram of another schematic example of a table including both defined and undefined data.

### DETAILED DESCRIPTION

Exemplary embodiments of a computer product, a data analysis support method, and a data analysis support apparatus will be described below in detail with reference to the accompanying drawings.

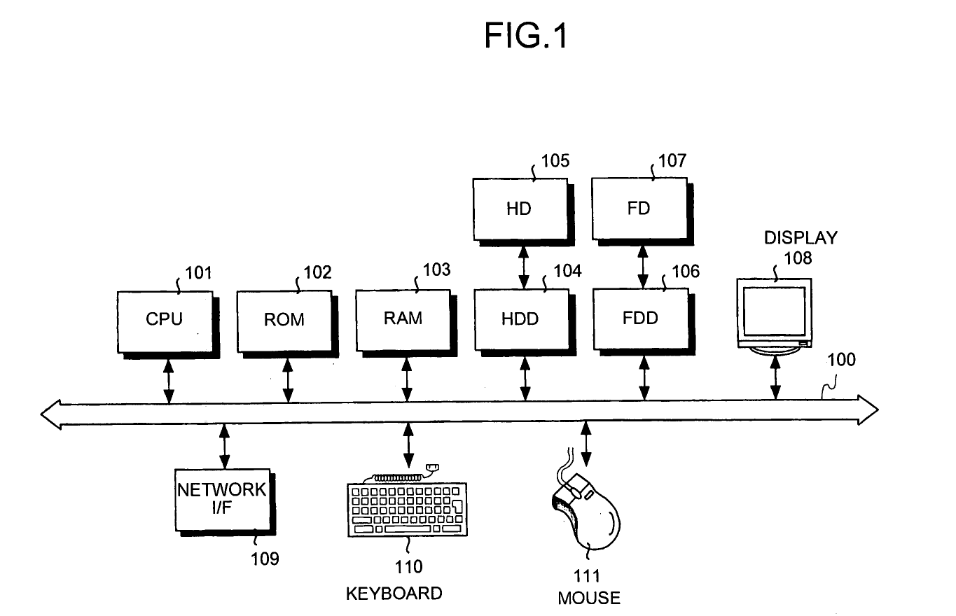

FIG. 1 is a hardware configuration of a data analysis support apparatus according to an embodiment of the present invention. In this data analysis support apparatus, a central processing unit (CPU) 101 controls the whole apparatus, a read only memory (ROM) 102 stores therein a boot program or the like, and random access memory (RAM) 103 is used as a work area of the CPU 101.

Moreover, a hard disk drive (HDD) 104 controls read/write of a hard disk (HD) 105 under the control of the CPU 101. The HD 105 stores data written therein under the control of the HDD 104. A floppy disk drive (FDD) 106 controls read/write of a floppy disk (FD) 107 under the control of the CPU 101. The FD 107 stores data written therein under the control of the FDD 106. The FD 107 is an example of a removable recording medium, and it may be replaced with CD-ROM, (CD-R, CD-RW), magneto-optical (MO), digital versatile disk (DVD), a memory card, or the like.

A display 108 displays various data such as documents, images, including a cursor, windows, and icons. A network interface (I/F) 109 is connected to a network, such as local area network/wide area network (LAN/WAN), and controls transmission and reception of data between the network and the inside of the apparatus. A keyboard 110 is equipped with a plurality of keys for entering characters, numerical values, and various other commands, and inputs the data corresponding to a depressed one of the keys into the apparatus. A mouse 111 inputs into the inside of the apparatus the amount and direction of rotation of the mouse ball placed at the bottom of the mouse, and the ON/OFF state of each mouse button at the top of the mouse at any time. A bus 100 interconnects the units mentioned above.

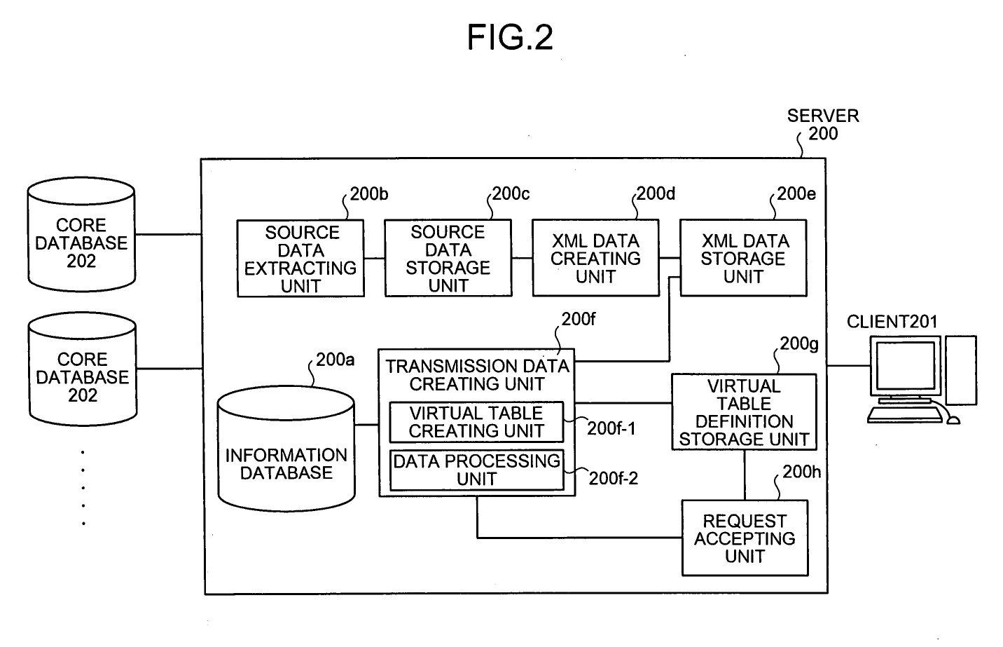

FIG. 2 is an explanatory diagram of the functional configuration of a data analysis support system that includes a data analysis support apparatus according to an embodiment of the present invention. This system is made up of a server 200, its client 201, and a core database 202 for use in each sales department. The server 200 and the client 201, and the server 200 and the core database 202 are interconnected via LAN or WAN, respectively.

The server 200 corresponds to the data analysis support apparatus according to the present invention. The server 200 complies with a request from the client 201 to process or convert defined data in its information database, or undefined data into a user-readable, tabular or graphical form. The data analysis support apparatus of the present invention features the advantage that enables analysis of undefined data yet to be normalized or cleansed as well as defined data.

The server 200 includes, as shown in FIG. 2, an information database 200a, a source data extracting unit 200b, a source data storage unit 200c, an XML data creating unit 200d, an XML data storage unit 200e, a transmission data creating unit 200f, a virtual table definition storage unit 200g, and a request accepting unit 202h.

The information database 200a is a database that stores various tables composed of data extracted from the core database 202 and subjected to the normalization and cleansing mentioned above. The procedure for extracting data from the core database 202 and the procedure for storing the extracted data in the information database 200a are the same as used in the conventional art; hence, no detailed description will be given of such procedures.

The source data extracting unit 200b is a unit that is connected to the core database 202 to extract therefrom data yet to be reflected in the information database. This extraction may be automatically carried out by the source data extracting unit 200b under the preset conditions: “when” and “how” the data is fetched “from where”. Alternatively, upon receiving the request for reference to data from the client 201, the associated data may be fetched from the associated core database 202. The data extracted by the source data extracting unit 200b is stored first in the source data storage unit 200c.

The form of the core database 202 may sometimes differ according to the circumstances of the department using it. For example, assume that a sales department A manages names and number of commodities sold in a predetermined relational database (RDB) form, whereas a sales department B stores slip files of Standard Generalized Markup Language (SGML) format in a predetermined document server. In this instance, to keep track of patterns of sales of a particular commodity in real time on a corporate-wide basis, it is necessary that the amount and volume of the commodity be summed up in the row direction irrespective of whether the data is extracted from RDB or slip file.

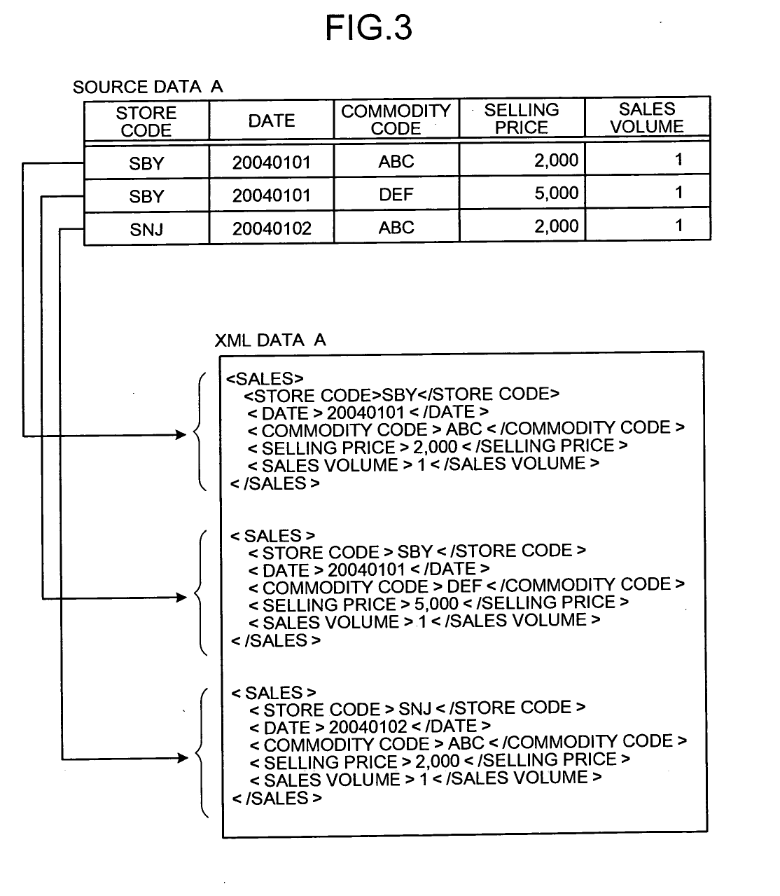

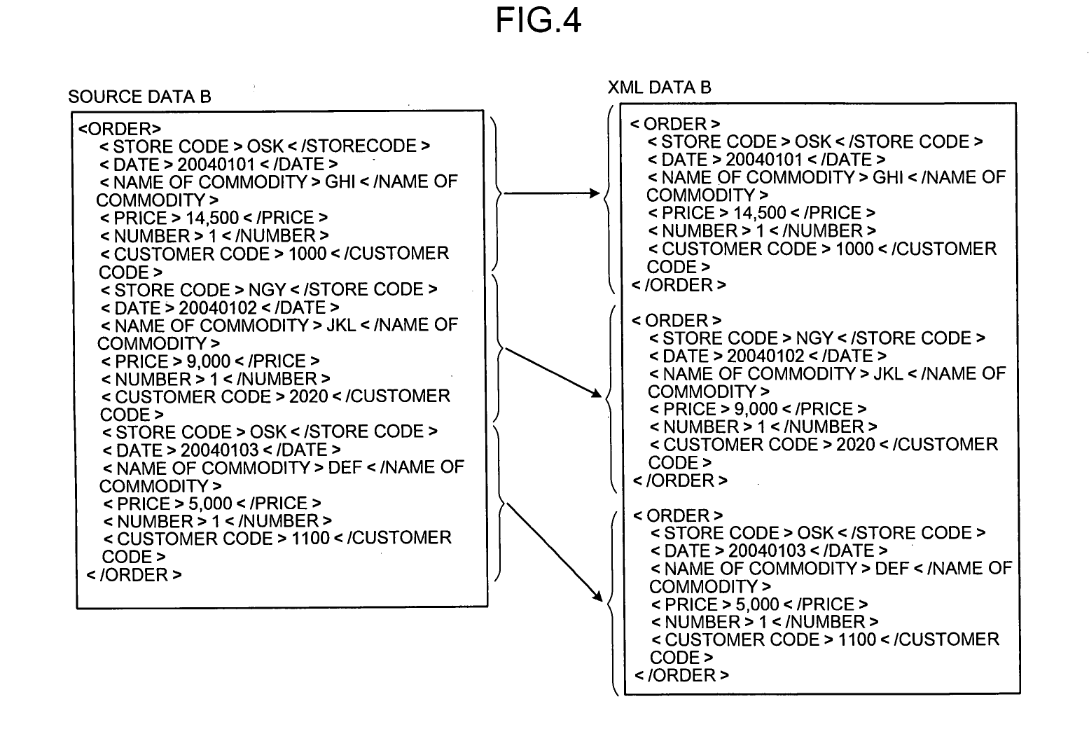

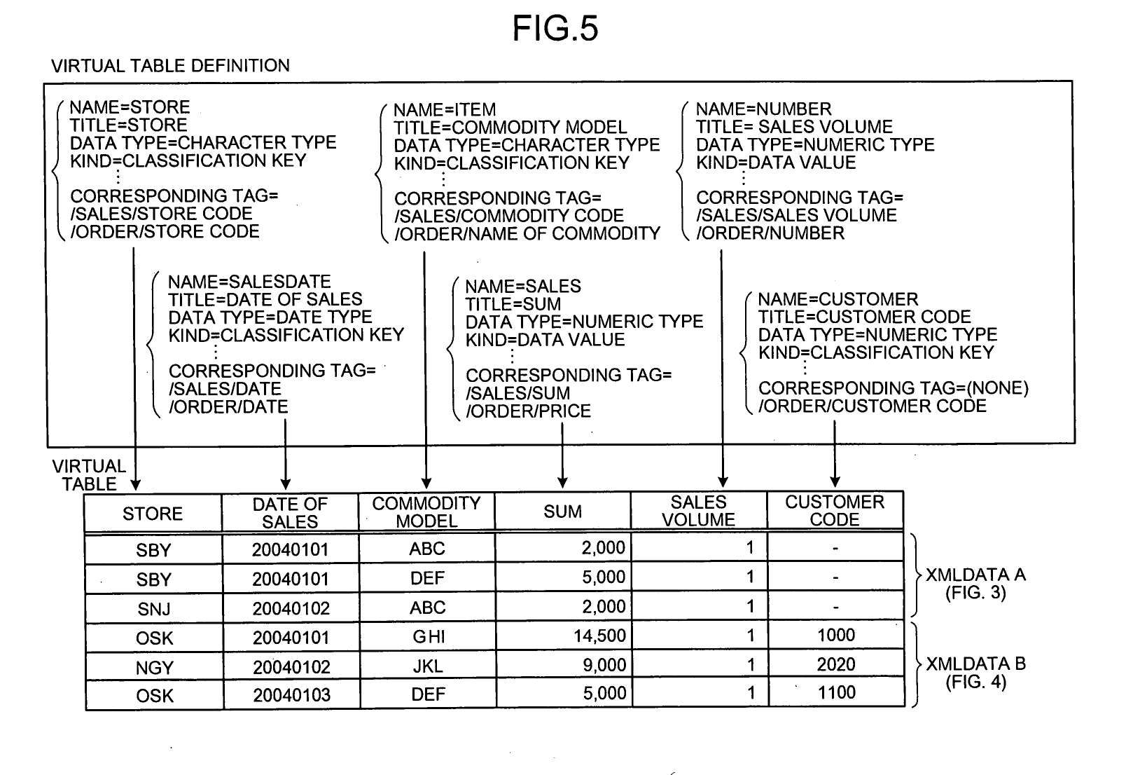

In view of the above, according to the present embodiment, pieces of source data extracted from various core databases 202 and stored in the source data storage unit 200c are all converted by the XML data creating unit 200d to XLM format. For example, if the data is extracted from RDB, individual records are converted to such an XML file as shown in FIG. 3. Even if the source data is already tagged, it may sometimes need to be separated into individual cases as shown in FIG. 4. The XML data creating unit 200d follows conversion rules preset therein to create such an XML file as shown in FIG. 3 or 4 and stores its created XML file in the XML data storage unit 200e.

Turning back to FIG. 2, the transmission data creating unit 200f is a unit that creates a table or a graph to be sent to the client 201 having requested for reference to undefined data. As shown in FIG. 2, the transmission data creating unit 200f includes: a virtual table creating unit 200f-1 that creates a virtual table from the XML file in accordance with a virtual table definition held in the virtual table definition storage unit 200g; and a data processing unit 200f-2 that processes data in the created virtual table under instructions from a user.

FIG. 5 is an explanatory diagram of, by way of a schematic example, the virtual table definition and the virtual table that is created according to the definition. Each virtual table is given a unique identifier such as “SALES”, and its items are also given identifiers such as “STORE”, “SALESDATE”, and so forth. For each item, there are defined its attributes such as the title (header string for a display), data format, and correspondence to tags in the XML file.

For instance, when instructed to create a table “SALES”, the virtual table creating unit 200f-1 searches a file having the tags from the XML file in the XML data storage unit 200e and extracts data in the tags from the searched file for use as values in the corresponding item. Accordingly, the item “STORE” in the “SALES” table has, as its values, “SBY”, “SBY”, and “SNJ” extracted from a tag “STORECODE” under the tag of “SALES” in FIG. 3, or “OSK”, “NGY”, and “OSK” extracted from the tag “STORECODE” under the tag of “ORDER” in FIG. 4.

When no corresponding tag is found in the XML file, the value of the corresponding item in the virtual table is expressed as NULL (indicated by “-” in FIG. 5). Since the XML file shown in FIG. 3 does not include the tag corresponding to item “CUSTOMER” (specifically, “CUSTOMERCODE” tag under the tag of “ORDER”), item “CUSTOMERCODE” in the data extracted from the file concerned is indicated by “-”.

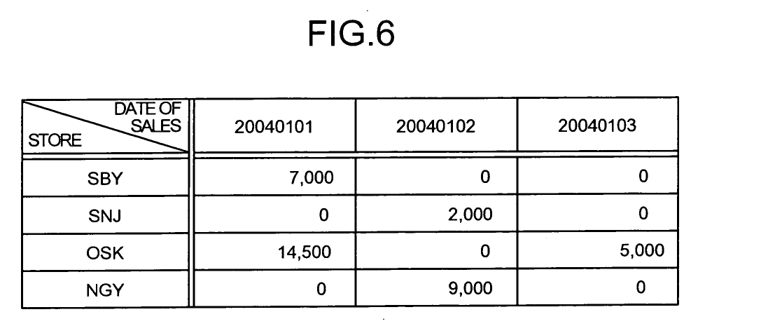

For example, when the client 201 requests to add up the values of item “SALES” in the table “SALES” for each of the items “STORE” and “SALESDATE” and to draw up a two-dimensional table with “STORE” in the column direction and “SALESDATE” in the row direction, the data processing unit 200f-2 creates such a two-dimensional table as shown in FIG. 6 from the virtual table of FIG. 5.

Turning back to FIG. 2, the request accepting unit 200h is a unit that receives from the client 201 a request for reference to data and, at the same time, inquires the client 201 about matters necessary to meet the request, that is, “what data do you want to see in which form”, and provides the reply from the client 201 to the transmission data creating unit 200f.

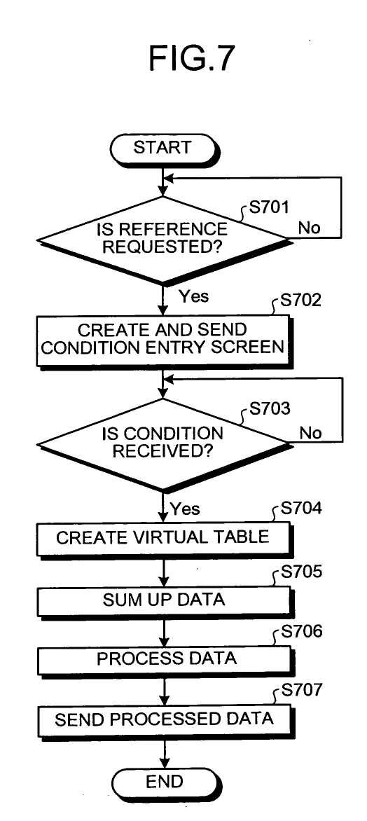

FIG. 7 is a flowchart of a process procedure for processing undefined data in the data analysis support apparatus according to the embodiment of the present invention. Upon receiving a data reference request from the client 201 (step S701: Yes), the request accepting unit 200h of the server 100 first refers to the virtual table definition storage unit 200g to create a condition entry screen for users to specify the scope of data desired and how to process the data, and sends the screen to the client 201 (step S702).

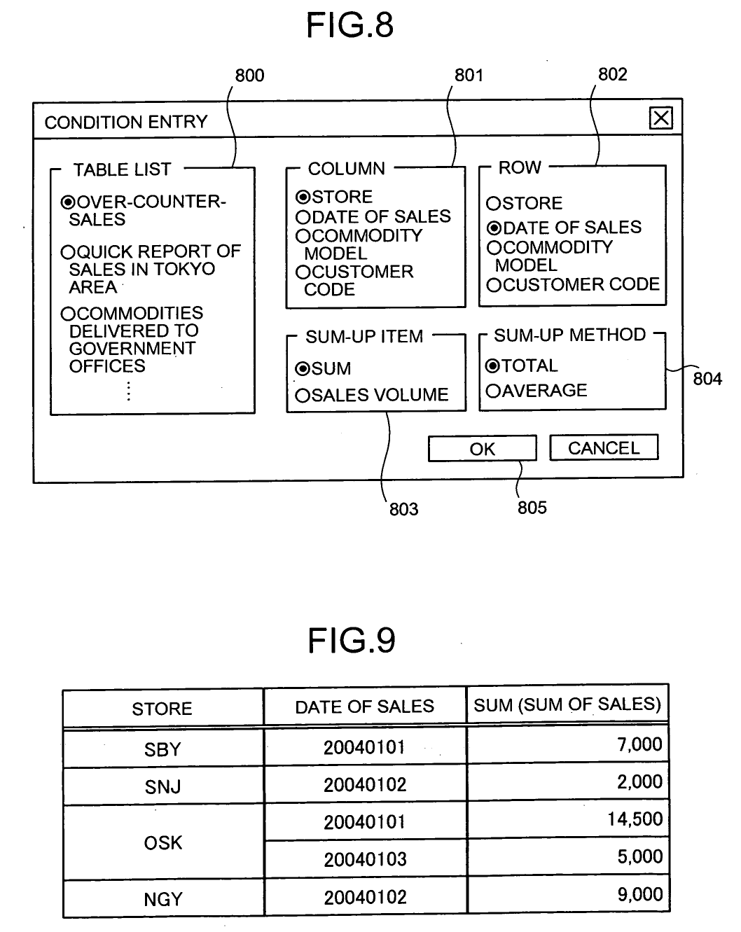

FIG. 8 is an explanatory diagram of an example of the display on the above screen in the client 201. A table select area 800 is an area for user to specify the scope of data desired; in this area there are displayed titles of all virtual tables whose definitions are held in the virtual table definition storage unit 200g. Every title of the table is displayed here, and for instance, it is assumed that the title of the “SALES” table is “OVER-COUNTER-SALES”.

A column direction select area 801 and a row direction select area 802 are areas for the user to specify the direction for summing up by the data processing unit 200f-2. In this area there are displayed titles of those of the items in the table “SALES” selected in the table select area 800 which are “CLASSIFICATIONKEY”, in specific terms, titles “STORE”, “SALESDATE”, “COMMODITYMODEL”, and “CUSTOMERCODE” of the items “STORE”, “SALESDATE”, “ITEM”, and “CUSTOMER”.

A sum-up item selecting area 803 is an area for the user to specify the subject of summation by the data processing unit 200f-2. In this area there are displayed titles of those of the items in the table “SALES” selected in the table select area 800 which are “DATAVALUE”, in specific terms, titles “PROCEEDS” and “SALESVOLUME” of the items “SALES” and “NUMBER”. A sum-up method select area 804 enables the user to select whether to calculate a sum total or average of values in the selected sum-up item.

When a different table is selected in the table select area 800, the selected table is posted from the client 201 to the server 200, and the classification key item and a data value item specified based on the definition of the selected table is sent back to the client 201. The display contents of the column direction select area 801, the row direction select area 802, and the sum-up item select area 803 are switched according to the table being selected.

Thereafter, when the user of the client 201 enters required matters and depresses an OK button 805, the designated contents on the screen are sent back to the server 200 from the client 201, and the transmission data creating unit 200f receives the matters via the request accepting unit 200h (step S703: Yes). As shown in FIG. 8, it is assumed that “STORE” (“Sales-over-the Counter” in FIG. 8) is designated as the table, “STORE” (“Store”) in the column direction for summation, “SALESDATE” (“Date of Sales”) in the row direction for summation, “SALES (“Amount of Sales”) as the item of summation and “Sum Total” as the method of summation.

In the transmission data creating unit 200f, the virtual table creating unit 200f-1 refers to the definition of the table “SALES” in the virtual table definition storage unit 200e and creates such a virtual table “SALES” as shown in FIG. 5 from the data in the XML data storage unit 200e (step S704).

The data processing unit 200f-2 then sums up values of the designated item “SALES” in the table for each of the items “STORE” and “STOREDATE” (step S705). FIG. 9 is a schematic explanatory diagram of the results of summation. The table shown in FIG. 9 gives the sums of amounts of sales for each store and for each date of sales, but the table is not in the form of a two-dimensional table with the user's designated “STORE” and “SALESDATE” in the column and row directions, respectively. The data processing unit 200f-2 then rearranges the data positions in the table, ultimately creating such a two-dimensional table as shown in FIG. 6 (step S706).

The table is handed from the transmission data creating unit 200f to the request accepting unit 200h, from which it is sent to the client 201 (step S707).

According to the embodiment described above, even undefined data (data just created but not yet subjected to normalization and cleansing) can be referred to from the client 201 as is the case with defined data. Accordingly, a real-time data analysis based on fresh data, which is impossible with the conventional OLAP, can be achieved.

The pieces of data extracted from the core database 202 are all converted to the XML format, and plural XML tags can be associated with the same item of the virtual table; hence, even when the database configuration or table configuration differs among sales departments, the table or the graph that is provided to the user can accommodate the difference.

The table differs from a constant table in the information database 200a in that it is created on an ad-hoc basis upon receiving the request for reference from the user and is based on undefined data with no guarantee of its accuracy and integrity (that is why the term “virtual” is used), but this table is identical in form with the table in the information database 200a.

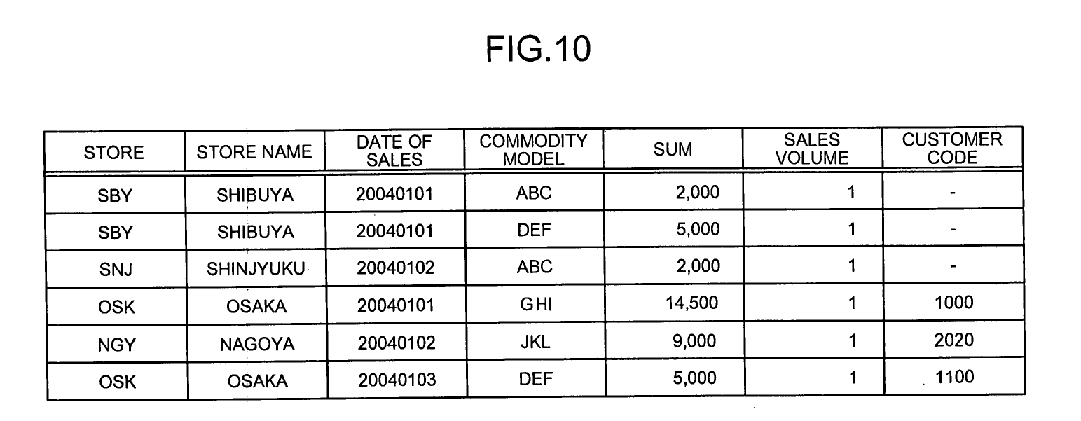

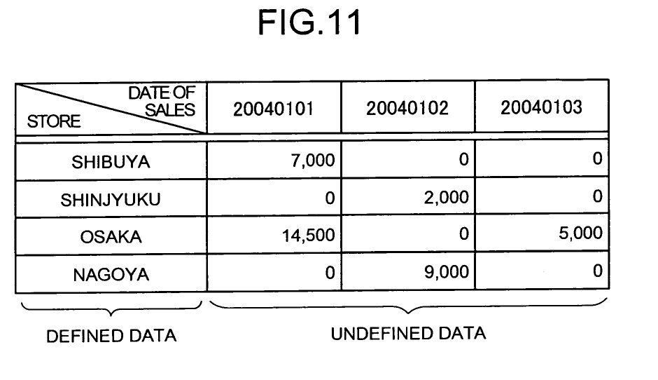

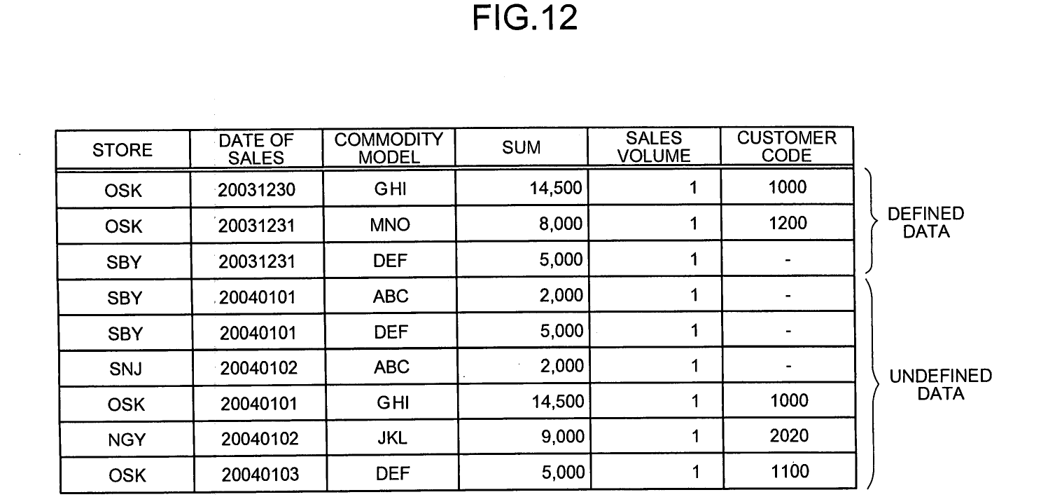

For example, if the virtual table “SALES” is combined with a store master table in the information database 200a to create such a table as shown in FIG. 10 (a table with item “Store Name” added to the virtual table of FIG. 5), it is also possible to provide such a two-dimensional table as shown in FIG. 11, in which the names of store are arranged in the column direction (in FIG. 6, on the contrary, the store codes are arranged in the column direction). It is an example in which defined data is added in the column direction, but it is also possible to add defined data in the column direction to create a table in which records composed of only defined data and records composed of only undefined data are mixed as shown in FIG. 12. By properly combining the table in the information database 200a with the virtual table, it is possible to make a seamless analysis of defined and undefined data that is impossible with the conventional art.

The data analysis support method described above can be implemented by executing a computer program on computers such as a personal computer or a workstation. The computer program is recorded on a computer-readable recording medium such as the HD 105, the FD 107, CD-ROM, MO, and DVD, and it can be executed by being read out of the recording medium by the computer. The computer program may be distributed over a network such as the Internet.

According to the present invention, a data analysis support program, a data analysis support method, and a data analysis support apparatus for supporting data analysis targeting on the data yet to be stored in the data warehouse can be provided.

Moreover, even undefined data yet to be stored in the data warehouse can be used to create a virtual table of the same format as a table in the data warehouse for analysis by OLAP.

Furthermore, variations in the format of undefined data can be accommodated using markup of each document as a medium to create a virtual table of the same format as tables in the data warehouse on an organization-wide basis for analysis by OLAP.

Moreover, variations in the format of undefined data can be accommodated using an XML tag of each document as a medium to create a virtual table of the same format as tables in the data warehouse on an organization-wide basis for analysis by OLAP.

In addition, it is possible to create a table of data mixed therein for analysis by OLAP, regardless of the data to be defined or undefined.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program that contains instructions which when executed on a computer cause the computer to execute:
creating a markup document from data yet to be stored in a data warehouse;
searching a markup document, from among the markup documents created, for a tag corresponding to an item of a designated table;
extracting data in the tag from hit markup document;
creating a designated table with the data extracted as a value of the item; and
processing data in the designated table created to a designated format.

2. The data analysis support program according to claim 1, wherein a plurality of tags correspond to each item of the designated table.

3. The data analysis support program according to claim 1, wherein the creating a markup document includes creating the markup document in XML format.

4. The data analysis support program according to claim 1, further comprising combining the designated table created at the creating a designated table with a table in the data warehouse to thereby obtain a combined table,
wherein the processing data includes processing data in the combined table into the designated format.

5. A data analysis support method comprising:
creating a markup document from data yet to be stored in a data warehouse;
searching a markup document, from among the markup documents created, for a tag corresponding to an item of a designated table;
extracting data in the tag from hit markup document;
creating a designated table with the data extracted as a value of the item; and
processing data in the designated table created to a designated format.

6. The data analysis support method according to claim 5, wherein a plurality of tags correspond to each item of the designated table.

7. The data analysis support method according to claim 5, wherein the creating a markup document includes creating the markup document in XML format.

8. The data analysis support method according to claim 5, further comprising combining the designated table created at the creating a designated table with a table in the data warehouse to thereby obtain a combined table,
wherein the processing data includes processing data in the combined table into the designated format.

9. A data analysis support apparatus comprising:
a document creating unit that creates a markup document from data yet to be stored in a data warehouse;
a searching unit that searches a markup document, from among the markup documents created, for a tag corresponding to an item of a designated table;
an extracting unit that extracts data in the tag from hit markup document;
a table creating unit that creates the designated table with the data extracted as a value of the item; and
a data processing unit that processes data in the designated table created to a designated format.

10. The data analysis support apparatus according to claim 9, wherein a plurality of tags correspond to each item of the designated table.

11. The data analysis support apparatus according to claim 9, wherein the document creating unit creates the markup document in XML format.

12. The data analysis support apparatus according to claim 9, further comprising a combining unit that combines the designated table created by the table creating unit a designated table with a table in the data warehouse to thereby obtain a combined table,
wherein the data processing unit processes data in the combined table into the designated format.

13. A computer-readable recording medium that stores a computer program that contains instructions which when executed on a computer cause the computer to execute:
creating a markup document from data yet to be stored in a data warehouse;
searching a markup document, from among the markup documents created, for a tag corresponding to an item of a designated table;
extracting data in the tag from hit markup document;
creating a designated table with the data extracted as a value of the item; and
processing data in the designated table created to a designated format.
